(19) United States
(12) Patent Application Publication
(10) Pub. No.: US 2007/0134135 A1
(43) Pub. Date: Jun. 14, 2007

(54) Disposable Reaction Cuvette Segment for Use in Full Automatic Chemistry Analyzers

(75) Inventors: Quan Li, Guangdong Province (CN); Shicai Li, Guangdong Province (CN); Xiaodong Xing, Guangdong Province (CN); Zaixing Gao, Guangdong Province (CN)

Correspondence Address: MYERS BIGEL SIBLEY & SAJOVEC, PO BOX 37428, RALEIGH, NC, 27627, US

(73) Assignee: Shenzhen Mindray Bio-Medical Electronics Co., Ltd.

(21) Appl. No.: 11/564,903

(22) Filed: Nov. 30, 2006

(30) Foreign Application Priority Data
Dec. 12, 2005 (CN) 200520120652.5

(51) Int. Cl. B01L 3/00

(52) U.S. Cl. 422/102

(57) ABSTRACT

The present invention relates to a disposable reaction cuvette segment for use in full automatic chemistry analyzers, which is a curved cuvette segment (1) comprising at least three open-ended cuvettes (11). Connecting webs (12) are arranged on the top surface between every two adjacent cuvettes (11) and on the upper part of the front and back sides of the cuvettes. The lower part of the cuvette (11) is an optical surface (13). Two fixing protrusions (15) of the same height arranged at the same level are provided vertically down on the top of the inner side of the curved cuvette segment (1), and inside each of these protrusions there is set a vertically oriented mounting hole (16) having a round or tapered shape. As compared with the prior art, the present invention has such advantages as simpler structure, accurate positioning and convenience for installing and replacing.

### STATEMENT OF THE RELATED APPLICATION

The present application claims the priority of the Chinese Patent Application No. 200520120652.5, filed on Dec. 12, 2005, entitled “Disposable Reaction Cuvette Segment for Use in Full Automatic Chemistry Analyzers”, the disclosure of which is fully incorporated herein by reference.

### FIELD OF THE INVENTION

The present invention relates to a medical apparatus, more particularly to a disposable reaction cuvette segment for use in full automatic chemistry analyzers.

### BACKGROUND OF THE INVENTION

Generally, the prior art disposable reaction cuvette segment used in medium and low grade chemistry analyzers is a curved cuvette segment comprising at least three open-ended cuvettes. On the top of the cuvette segment, a flange of certain thickness is respectively set on the inner and outer curves. Curved grooves are uniformly set around the circumference of the reaction disk in the analyzer. During the process of application, the curved cuvette segment is placed into the curved grooves. Such a disposable reaction cuvette segment is subjected to the following deficiencies: 1) as the reaction cuvette segment is vertically positioned by contacting the bottom surface of the flange with the reaction disk, and as it is difficult to keep the bottom surface of the flange flat, consequently the longer the cuvette segment is, the more serious the problem becomes. As such, it is hard to perfectly position the cuvette segment in vertical direction. 2) As the reaction cuvette segment is so positioned in radial and tangential directions of the circumference as to be influenced by how well the shape of the cuvette segment matches the curved grooves on the reaction disk, inaccurate positioning tends to cause the center of the beam to deviate from the center of the optical surface of the reaction cuvette, thereby causing measurement errors. 3) It is inconvenient to set up and replace the reaction cuvette segment. 4) Relatively high accuracy as to the spinning of the reaction disk is required.

### SUMMARY OF THE INVENTION

It is an object of the present invention to provide an improved disposable reaction cuvette segment for use in full automatic chemistry analyzers, which enables accurate positioning and measurement and is easily installable and replaceable.

The object of the present invention may be realized by employing the following technical solutions.

A disposable reaction cuvette segment for use in full automatic chemistry analyzers is devised, which is a curved cuvette segment comprising at least three cuvettes, wherein two or more fixing protrusions are provided on the inner side of the curved cuvette segment, and a mounting hole is set within each of the fixing protrusions.

Connecting webs are arranged on the top surface between every two adjacent cuvettes as well as on the upper part of the front and back sides of the cuvettes.

The above-mentioned two or more fixing protrusions extend vertically downward from the top of the inner side of the curved cuvette segment and are arranged at the same level.

The mounting hole is a round hole or a tapered hole.

The fixing protrusion is a cylinder.

Every two adjacent fixing protrusions are arranged symmetrically with respect to the radial line halving the curved cuvette segment, and the centers of the mounting holes are located on a circumference concentric with the inner arc of the curved cuvette segment.

The connecting webs arranged on the top surface of the curved cuvette segment and on the top surface between every two adjacent cuvettes extend radially inward and outward, such that an inner flange and an outer flange are formed near the mouth of the cuvette.

The two fixing protrusions extend vertically from the bottom surface of the flange formed on the inner side of the cuvette segment to the bottom of the cuvette.

The curved cuvette segment comprises ten cuvettes.

The mounting hole is vertically oriented.

The lower part of the cuvette is an optical surface.

The cuvette is open-ended.

As compared with the prior art, this disposable reaction cuvette segment for use in full automatic chemistry analyzers has the following advantages: 1) It is simply structured and thereby can be easily manufactured. 2) It guarantees accurate positioning. Specifically, as the reaction cuvette segment is vertically positioned by contacting the bottom surface of the fixing protrusion with the reaction disk, due to small contacting area, it is easy to obtain accurate positioning; in the radial and tangential directions of the reaction cuvette segment, accurate positioning is guaranteed by matching the mounting holes having a round or tapered shape to the mating pegs on the reaction disk. 3) The reaction cuvette segment is easily installable and replaceable.

### BRIEF DESCRIPTION OF THE DRAWINGS

FIG. 1 is a schematic isometric view showing the inner side of the reaction cuvette segment

FIG. 2 is a schematic isometric view showing the outer side of the reaction cuvette segment.

FIG. 3 is a schematic isometric view showing the inner side of the upside-down reaction cuvette segment.

FIG. 4 is a schematic structural view showing the reaction cuvette segment being installed on a corresponding reaction disk.

### MODES FOR CARRYING OUT THE PRESENT INVENTION

The present invention is hereunder described in more details with reference to the figures.

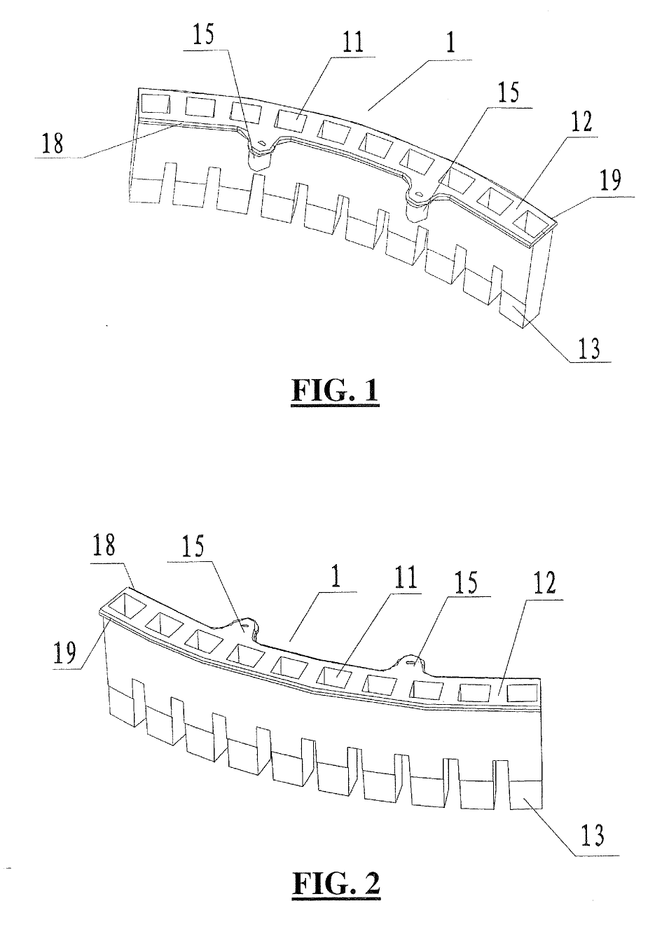

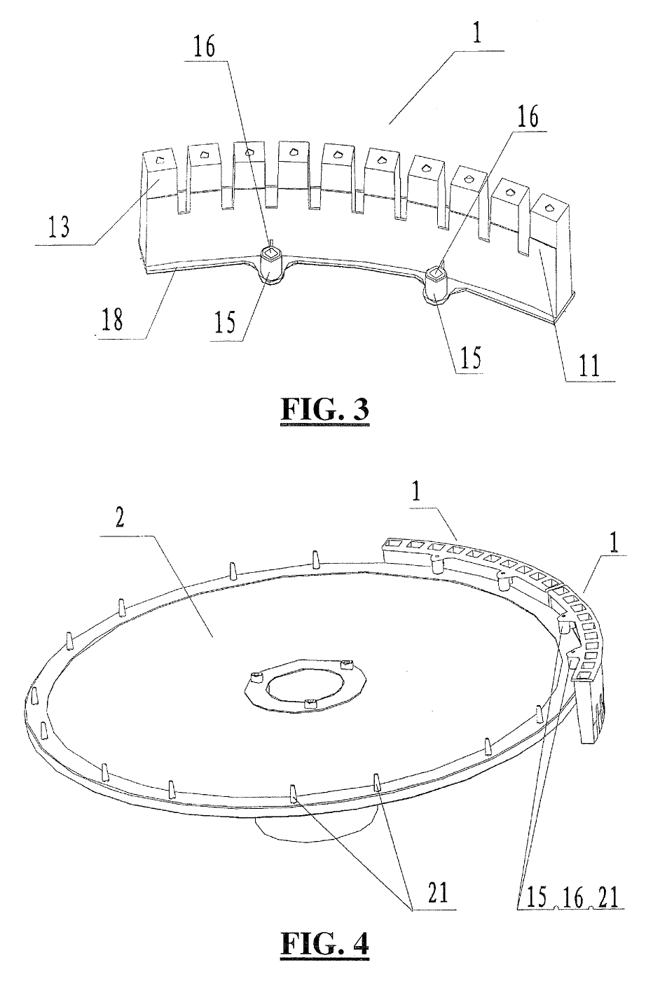

The present invention relates to a disposable reaction cuvette segment for use in full automatic chemistry analyzers. As shown in FIGS. 1 to 3, a curved cuvette segment 1 is provided, comprising ten cuvettes 11 that are preferably open-ended. However, it is apparent to those skilled in the art that the disposable reaction cuvette segment according to the present invention may comprise more or less cuvettes 11, such as two, three or more. Connecting webs 12 are arranged on the top surface between every two adjacent cuvettes 11 as well as on the upper part of the front and back sides of the cuvettes 11. The lower part of the cuvette 11 is optical surface 13. On the inner side of the curved cuvette segment 1, two cylindrical fixing protrusions 15 of the same height and preferably the same diameter arranged at the same level are mounted extending vertically downward and symmetrically with respect to the radial direction of the cuvette segment 1. However, those skilled in the art may understand that there may be more than two fixing protrusions 15, which may have different heights and diameters, and may as well be arranged asymmetrically with respect to the radial direction, as long as the protrusions are so arranged as to match with the corresponding pegs 21 on the reaction disk 2. Inside each of these two fixing protrusions 15 there is provided a vertical mounting hole 16, which may have a round shape, a tapered shape or any other shapes. The centers of the two holes 16 may be located on a circumference concentric with the inner arc of the curved cuvette segment 1, so that the corresponding pegs 21 can fit into the holes. Of course, the number, shape and orientation of the positioning hole 16 may be altered to conform to different number, orientation and settings of the pegs 21 as required in different applications. For example, there may be more than two mounting holes 16, and the holes may have different shapes corresponding to the pegs 21 and are not necessarily vertically oriented. In order for an aesthetic appearance and to strengthen the connection between the cuvettes 11, connecting webs 12 arranged on the top of the curved cuvette segment 1 as well as the upper part of the two adjacent cuvettes 11 extend radially inward and outward, forming inner and outer flanges 18 and 19 around the mouth of the cuvettes. As shown in the figures, these two fixing protrusions 15 are formed on the bottom surface of the inner flange 18 of the cuvette segment, extending vertically to the bottom of the cuvettes, and are located on the connecting web 12 connecting the third and the fourth cuvettes from both ends of the reaction cuvette segment. During use, as shown in FIG. 4, these two fixing protrusions 15 are fit to the mating pegs 21 arranged on the corresponding reaction disk 2. Since the peg 21 fits into the fixing protrusion 15 via a cylindrical surface or a tapering surface, the radial and tangential positioning is accurate, and meanwhile it provides convenience for the operators to install or replace the reaction cuvette segment.

1. A disposable reaction cuvette segment for use in automatic chemistry analyzers, which is a curved cuvette segment comprising at least three cuvettes, wherein two or more fixing protrusions are provided on the inner side of the curved cuvette segment, and a mounting hole is set in each of the fixing protrusions.

2. The disposable reaction cuvette segment according to claim 1, wherein connecting webs are arranged on the top surface between every two adjacent cuvettes as well as on the upper part of the front and back sides of the cuvettes.

3. The disposable reaction cuvette segment according to claim 1, wherein said two or more fixing protrusions extend vertically downward from the top of the inner side of the curved cuvette segment and are arranged at the same level.

4. The disposable reaction cuvette segment according to claim 1, wherein the mounting hole is a round hole or a tapered hole.

5. The disposable reaction cuvette segment according to claim 1 or 2, wherein the fixing protrusion is a cylinder.

6. The disposable reaction cuvette segment according to claim 5, wherein every two adjacent fixing protrusions are arranged symmetrically with respect to the radial line halving the curved cuvette segment, and the centers of the mounting holes are located on a circumference concentric with the inner arc of the curved cuvette segment.

7. The disposable reaction cuvette segment according to claim 2, wherein the connecting webs arranged on the top surface of the curved cuvette segment and on the upper part between every two adjacent cuvettes extend radially inward and outward, such that an inner flange and an outer flange are formed near the mouth of the cuvettes.

8. The disposable reaction cuvette segment according to claim 7, wherein said two fixing protrusions extend vertically from the bottom surface of the flange formed on the inner side of the cuvette segment to the bottom of the cuvette.

9. The disposable reaction cuvette segment according to claim 1, wherein the curved cuvette segment comprises ten cuvettes.

10. The disposable reaction cuvette segment according to claim 1, wherein the mounting hole is vertically oriented.

11. The disposable reaction cuvette segment according to claim 1, wherein the lower part of the cuvette is an optical surface.

12. The disposable reaction cuvette segment according to claim 1, wherein the cuvette is open-ended.
